(19) United States
(12) Patent Application Publication
(10) Pub. No.: US 2022/0057760 A1
(43) Pub. Date: Feb. 24, 2022

(54) INFORMATION PROCESSING APPARATUS, INFORMATION PROCESSING SYSTEM, INFORMATION PROCESSING METHOD, AND TERMINAL APPARATUS

(71) Applicant: Toyota Jidosha Kabushiki Kaisha, Toyota-shi Aichi-ken (JP)

(72) Inventors: Shin Sakurada, Toyota-shi Aichi-ken (JP); Yasuhiro Baba, Kamo-gun Gifu-ken (JP); Shuichi Sawada, Nagoya-shi Aichi-ken (JP); Shintaro Matsutani, Kariya-shi Aichi-ken (JP); Yurika Tanaka, Yokosuka-shi Kanagawa-ken (JP); Ryosuke Kobayashi, Nagakute-shi Aichi-ken (JP); Genshi Kuno, Kasugai-shi Aichi-ken (JP); Tomoya Makino, Kariya-shi Aichi-ken (JP)

(21) Appl. No.: 17/404,464

(22) Filed: Aug. 17, 2021

(30) Foreign Application Priority Data
Aug. 19, 2020 (JP) 2020-138956

(51) Int. Cl. G05B 13/02; F24F 11/63

(52) U.S. Cl. CPC G05B 13/028; F24F 2130/20; F24F 11/63

(57) ABSTRACT

An information processing apparatus includes a controller. The controller acquires sunshine state information that specifies a sunshine state of at least one predetermined spot and repeated behavior information for a user that is associated with the at least one predetermined spot. The controller generates behavior proposal information related to performance of a repeated behavior of the user, based on the sunshine state information and on the repeated behavior information for the user, and outputs the behavior proposal information.

### CROSS-REFERENCE TO RELATED APPLICATION

This application claims priority to Japanese Patent Application No. 2020-138956 filed on Aug. 19, 2020, the entire contents of which are incorporated herein by reference.

### TECHNICAL FIELD

The present disclosure relates to an information processing apparatus, an information processing system, an information processing method, and a terminal apparatus.

### BACKGROUND

A method for proposing a house to a customer using a set of drawings consisting of a plan view of the house, and a sectional view showing the degree of sunshine or the manner in which sunshine enters the house is known (for example, Patent Literature 1). Further, a system for providing customers with sunshine simulation information for real estate properties is known (for example, Patent Literature 2). Moreover, an apparatus for calculating the amount of solar radiation on a route is known (for example, Patent Literature 3).

### CITATION LIST

### Patent Literature

PTL 1: JP 2003-048387 A

PTL 2: JP 2001-236396 A

PTL 3: JP 2018-010009 A

### SUMMARY

Life of a user is affected by sunshine. To improve the quality of life of a user, information on a sunshine state can be used.

It would be helpful to improve the quality of life of a user.

An information processing apparatus according to an embodiment of the present disclosure includes a controller. The controller is configured to: acquire sunshine state information that specifies a sunshine state of at least one predetermined spot and repeated behavior information for a user that is associated with the at least one predetermined spot; and generate behavior proposal information related to performance of a repeated behavior of the user, based on the sunshine state information and on the repeated behavior information for the user, and output the behavior proposal information.

An information processing system according to an embodiment of the present disclosure includes: the information processing apparatus; and a detection apparatus configured to detect information related to the sunshine state of the at least one predetermined spot.

An information processing method according to an embodiment of the present disclosure includes: acquiring sunshine state information that specifies a sunshine state of at least one predetermined spot; acquiring repeated behavior information for a user that is associated with the at least one predetermined spot; and generating behavior proposal information related to performance of a repeated behavior of the user, based on the sunshine state information and on the repeated behavior information for the user, and outputting the behavior proposal information.

A terminal apparatus according to an embodiment of the present disclosure includes a terminal controller. The terminal controller is configured to: output, to an information processing apparatus, repeated behavior information for a user that is associated with at least one predetermined spot; acquire, from the information processing apparatus, behavior proposal information related to performance of a repeated behavior of the user, the behavior proposal information being generated based on sunshine state information for the at least one predetermined spot and on the repeated behavior information for the user; and notify the user of the behavior proposal information.

According to the information processing apparatus, the information processing system, the information processing method, and the terminal apparatus according to the embodiments of the present disclosure, the quality of life of a user can be improved.

### BRIEF DESCRIPTION OF THE DRAWINGS

In the accompanying drawings:

FIG. 1 is a schematic diagram illustrating a configuration example of an information processing system according to an embodiment;

FIG. 2 is a block diagram illustrating a configuration example of the information processing system according to the embodiment; and

FIG. 3 is a flowchart illustrating an example of a procedure executed by a server.

### DETAILED DESCRIPTION

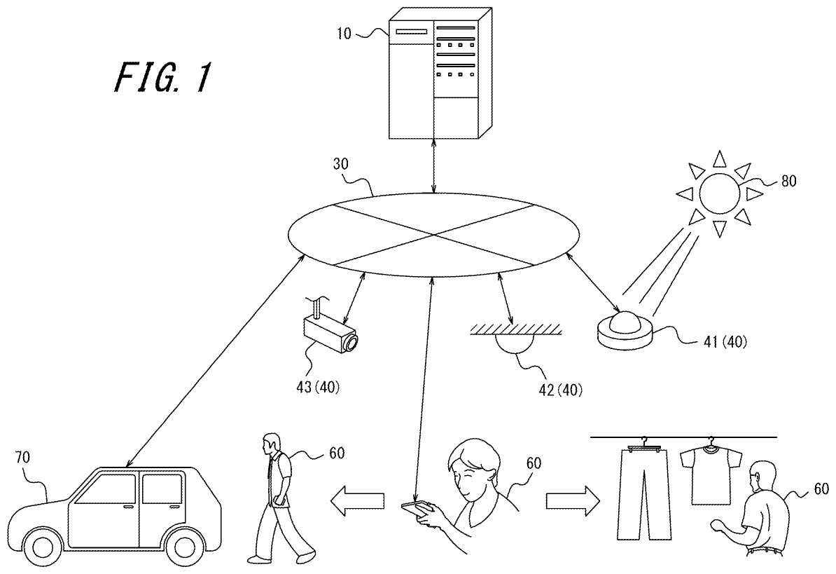

A user 60 (refer to FIG. 1) conducts various behaviors as behaviors repeatedly performed in their daily life. The behaviors that the user 60 repeatedly performs in the daily life are also referred to as lifestyle habits. The behaviors of the user 60 are affected by the amount of solar radiation. For example, in a case in which the user 60 does the laundry, a speed at which the laundry dries varies depending on the amount of solar radiation. Thus, a suitable time to do the laundry or a suitable place for hanging the laundry may be determined based on information related to the amount of solar radiation. Further, in a case in which the user 60 goes out, the user 60 finds the environment comfortable or uncomfortable when going out, depending on the amount of solar radiation. Thus, a suitable time for the user 60 to go out may be determined based on the information related to the amount of solar radiation. As described above, the quality of life of the user 60 can be improved by the user 60 conducting a suitable behavior based on the information related to the amount of solar radiation. It is desirable to propose a suitable behavior to the user 60.

(Outline of Information Processing System 1)

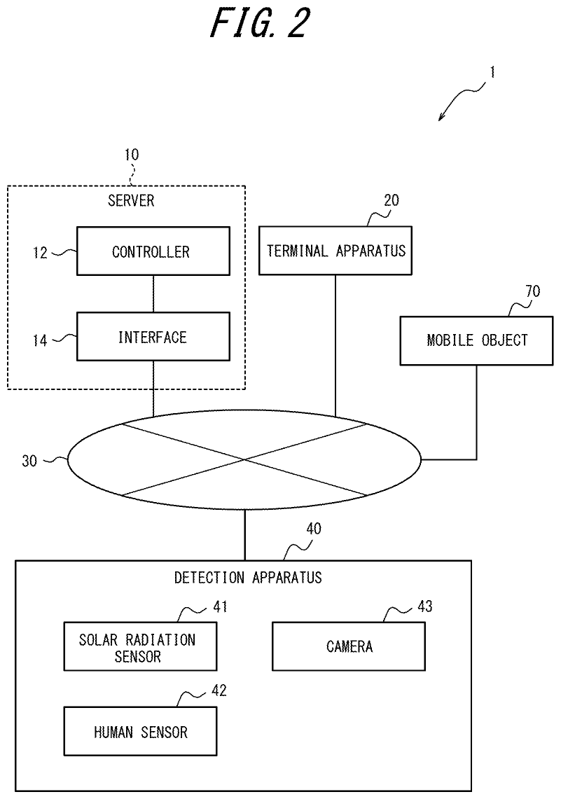

As illustrated in FIG. 1 and FIG. 2, an information processing system 1 according to an embodiment includes a server 10 and detection apparatuses 40. The detection apparatuses 40 are installed at or in the vicinity of the home of the user 60. The server 10 and the detection apparatuses 40 are connected to a network 30 and can communicate with each other. The number of servers 10 and the number of detection apparatuses 40 are not limited to one and may be two or more.

In the information processing system 1, the server 10 acquires, from a detection apparatus 40 or another apparatus, information related to a sunshine state at or in the vicinity of the home of the user 60. The information related to the sunshine state is also referred to as sunshine state information. The server 10 also acquires, from a detection apparatus 40 or another apparatus, information related to a repeated behavior of the user 60. Information related to a repeated behavior of the user 60 is also referred to as repeated behavior information. Based on the sunshine state information and the repeated behavior information, the server 10 determines a suitable behavior to be performed by the user 60. The server 10 proposes the determined behavior to the user 60 as a suitable behavior for the user 60. The server 10 proposes a behavior to the user 60, by generating and outputting information that specifies the behavior to be proposed to the user 60. Information related to performance of a repeated behavior of the user 60 is also referred to as behavior proposal information. By conducting a behavior based on the behavior proposal information, the user 60 can conduct a behavior in accordance with the sunshine state. The behavior in accordance with the sunshine state can make the user 60 comfortable. The behavior in accordance with the sunshine state can also be an efficient behavior. For example, the behavior in accordance with sunshine state may realize time savings. The behavior in accordance with the sunshine state can also bring about a good result from that behavior. As a result, the quality of life of the user 60 can be improved.

(Specific Example Configuration of Information Processing System 1)

A specific example configuration of the information processing system 1 will be described below.

<Detection Apparatus 40>

It is assumed that detection apparatuses 40 are installed at or in the vicinity of predetermined spots so as to detect various types of information for the predetermined spot. The detection apparatuses 40 are installed in the home of the user 60, or inside home premises or in the vicinity of the home. In other words, the detection apparatuses 40 can detect various types of information at the predetermined spots, such as spots in the home of the user 60, or spots included in the home premises or in the vicinity of the home.

<Acquisition of Sunshine State Information>

Each detection apparatus 40 detects the state of a predetermined spot at or in the vicinity of the home of the user 60 and outputs a detection result to the server 10. Based on the detection result of the state of the predetermined spot, a controller 12 of the server 10 estimates the sunshine state of the predetermined spot and acquires it as sunshine state information.

The detection apparatuses 40 include, but are not required to include, a solar radiation sensor 41. The solar radiation sensor 41 measures the amount of solar radiation from the sun 80 at a predetermined spot. The controller 12 acquires a measurement result of the amount of solar radiation as sunshine state information.

The detection apparatuses 40 include, but are not required to include, a camera 43. The camera 43 captures an image of a predetermined spot. Based on the image of the predetermined spot, the controller 12 estimates the amount of solar radiation from the sun 80 at the predetermined spot and acquires an estimation result as sunshine state information. Specifically, the controller 12 may estimate the amount of solar radiation from the sun 80 at the predetermined spot based on the brightness of the image of the predetermined spot.

The detection apparatuses 40 may include an illuminance sensor or an optical sensor. The illuminance sensor measures illuminance at a predetermined spot. The light sensor measures the amount of light at a predetermined spot. Based on the illuminance or the amount of light at the predetermined spot, the controller 12 may estimate the amount of solar radiation from the sun 80 at the predetermined spot and acquire an estimation result as sunshine state information.

The detection apparatuses 40 may include a temperature sensor. The temperature sensor measures the temperature at a predetermined spot. Based on the temperature at the predetermined spot, the controller 12 may estimate the amount of solar radiation from the sun 80 at the predetermined spot and acquire an estimation result as sunshine state information.

The detection apparatuses 40 are not limited to the above examples and may detect states of predetermined spots using various sensors. Based on various detection results at predetermined spots, the controller 12 may estimate sunshine states at the predetermined spots and acquire estimation results as sunshine state information. In this way, the controller 12 can acquire information indicating the sunshine states at that time as sunshine state information.

The controller 12 may associate various detection results at a predetermined spot with dates and times. The controller 12 may associate estimation results of the amount of solar radiation from the sun 80 at a predetermined spot with dates and times. The controller 12 may acquire changes in the amount of solar radiation from the sun 80 during a day at a predetermined spot, as sunshine state information at the predetermined spot. The controller 12 may acquire changes in the amount of solar radiation from the sun 80 during a year at a predetermined spot, as sunshine state information at the predetermined spot. In this way, the controller 12 can acquire information indicating a tendency of changes in the amount of solar radiation as sunshine state information.

The sunshine state of a predetermined spot varies depending on an environment in the vicinity of the predetermined spot. The controller 12 may update sunshine state information based on a detection result newly acquired from a detection apparatus 40 so that a change in the sunshine state is reflected in the sunshine state information.

The sunshine state of a predetermined spot changes, for example, depending on the arrangement of nearby buildings. Specifically, buildings in the vicinity of the predetermined spot may block sunshine from reaching the predetermined spot or reduce the amount of solar radiation at the predetermined spot. The buildings in the vicinity of the predetermined spot may also increase the amount of solar radiation at the predetermined spot by reflecting light from the sun 80 toward the predetermined spot. The sunshine state of a predetermined spot also changes depending on the arrangement of nearby trees or the conditions of the trees. For example, the longer the branches of the trees grow, the less the amount of solar radiation at the predetermined spot can be. Further, the more the leaves of the trees grow, the less the amount of solar radiation at the predetermined spot can be.

By updating sunshine state information at a predetermined spot, the controller 12 can reflect a change in the amount of solar radiation in the sunshine state information in accordance with a change in the environment.

The sunshine state of a predetermined spot also changes depending on the percentage of the sun 80 that is covered by a cloud. The controller 12 may estimate the percentage of the sun 80 that is covered by a cloud based on information related to the quantity of clouds or the like, and in accordance with an estimation result, correct the amount of solar radiation to be reflected in sunshine state information.

<Acquisition of Repeated Behavior Information>

A detection apparatus 40 detects the position of the user 60 or a history of travel of the user 60 at or in the vicinity of the home of the user 60, to be outputted to the server 10. Based on a detection result of the position or the history of travel of the user 60, the controller 12 of the server 10 estimates a repeated behavior of the user 60. By associating a repeated behavior of the user 60 with a spot at which the behavior is performed, the controller 12 acquires an estimation result of the repeated behavior of the user 60 that is associated with the predetermined spot as repeated behavior information of the user 60. The controller 12 may acquire the history of travel of the user 60 itself as repeated behavior information. The controller 12 may acquire a time when the user 60 goes outside or returns the home as repeated behavior information.

The detection apparatuses 40 include, but are not required to include, human sensors 42. The human sensors 42 are installed at various spots and detect the presence of the user 60 at the spots to thereby detect the position of the user 60. Based on information related to the position of the user 60, the controller 12 calculates the position or a history of travel of the user 60. Based on the position or the history of travel of the user 60, the controller 12 estimates a repeated behavior of the user 60 that is associated with a predetermined spot and acquires it as repeated behavior information for the user 60.

In a case in which the detection apparatuses 40 include a camera 43, the controller 12 estimates a repeated behavior of the user 60 that is associated with a predetermined spot, based on an image at the predetermined spot. The controller 12 may estimate a repeated behavior of the user 60 that is associated with the predetermined spot, further based on an image in the vicinity of the predetermined spot. The controller 12 acquires an estimation result of the repeated behavior of the user 60 that is associated with the predetermined spot as repeated behavior information of the user 60.

The controller 12 may estimate a repeated behavior of the user 60 by associating behaviors of the user 60 with dates, days of the week, and times. The controller 12 may estimate a behavior pattern of the user 60 as a repeated behavior of the user 60. The behavior pattern of the user 60 may include an order in which the user 60 moves around predetermined spots in the home, or may include a time period for which the user 60 stays at a predetermined spot in the home. The controller 12 may acquire a repeated behavior of the user 60 based on an operating status of a device installed in the home of the user 60.

<Server 10>

The server 10 includes a controller 12 and an interface 14. The server 10 acquires a detection result from a detection apparatus 40 through the interface 14. The controller 12 may regard a detection result itself as sunshine state information and repeated behavior information. The controller 12 may acquire sunshine state information and repeated behavior information by estimating sunshine state information and repeated behavior information based on a detected result. The controller 12 generates behavior proposal information based on sunshine state information and repeated behavior information. The server 10 is also referred to as an information processing apparatus. The server 10 may include a single server apparatus, or a plurality of server apparatuses capable of communicating with each other.

The controller 12 may include one or more processors. The “processors” in the present embodiment may be, but are not limited to, general-purpose processors, dedicated processors that are dedicated to specific processing, or the like. The controller 12 may include one or more dedicated circuits. Examples of the dedicated circuits may include a Field-Programmable Gate Array (FPGA) and an Application Specific Integrated Circuit (ASIC). The controller 12 may include the dedicated circuits instead of the processors, or may include the dedicated circuits along with the processors.

The server 10 may further include a memory. The memory may include an electromagnetic storage medium, such as a magnetic disc. The memory may include, for example, a semiconductor memory, a magnetic memory, an optical memory, or the like. The memory is not limited to the above examples and may include various storage devices. The memory may function as, for example, a main memory, an auxiliary memory, or a cache memory. The memory may include a non-transitory computer readable medium. The memory may store any information used for operations of the server 10. For example, the memory may store a system program, an application program, or the like. The memory may be included in the controller 12 or may be configured separately from the controller 12.

The interface 14 may include a connector, a port, or the like that can be connected to a cable for information input and acquisition based on various data communication standards, such as RS232C or RS485. The interface 14 may include a communication device. The communication device may communicate with a detection apparatus 40 via the network 30 or may communicate with a detection apparatus 40 without using the network 30. The communication device may include a communication module compliant with a mobile communication standard, such as the 4th Generation (4G) standard or the 5th Generation (5G) standard. The communication device may include a communication module compliant with a communication standard, such as a Local Area Network (LAN). The communication device is not limited to these and may include various other modules.

<Terminal Apparatus 20>

The information processing system 1 further includes, but is not required to include, a terminal apparatus 20. The controller 12 of the server 10 outputs generated behavior proposal information to the terminal apparatus 20 via the interface 14. The terminal apparatus 20 acquires the behavior proposal information from the server 10 and notifies the user 60.

The terminal apparatus 20 includes an output device for notifying the user 60 of behavior proposal information. The output device may include a display device so as to cause the user 60 to visually recognize behavior proposal information. The display device may include various displays, such as a liquid crystal display, or an organic or inorganic Electro-Luminescent (EL) display. The display device may include a light emitting device, such as a Light Emitting Diode (LED). The output device may include an audio output device, such as a speaker, so as to cause the user 60 to audibly recognize behavior proposal information. The output device is not limited to these and may include various other devices.

The terminal apparatus 20 may include a terminal controller that performs a process for implementing various functions, such as control of an output device. The terminal controller may be configured with a processor. The processor may be configured in a manner similar to the processors constituting the controller 12 of the server 10.

The terminal apparatus 20 may include, for example, a mobile terminal such as a smartphone. The terminal apparatus 20 may include a portable terminal, such as a tablet Personal Computer (PC) or a notebook PC. The terminal apparatus 20 may include, for example, a desktop PC or the like. The terminal apparatus 20 may be installed in the home of the user 60 or may be carried by the user 60.

(Specific Operation Example of Information Processing System 1)

Hereinafter, a specific operation example of the information processing system 1 will be described.

<Behavior Proposal Related to Laundry>

As a repeated daily behavior, the user 60 can do the laundry at home and hang the laundry in a home garden, on a veranda, or the like, in order to dry the laundry using sunshine from the sun 80. The controller 12 of the server 10 acquires sunshine state information for a predetermined spot in the home of the user 60, such as a spot like the garden or the veranda where the laundry is hung. Based on the sunshine state information, the controller 12 may estimate a time when it is likely that sunshine can be used to dry the laundry as a time to do the laundry. The controller 12 may estimate a time to do the laundry further based on a habitual time to do the laundry that is specified by repeated behavior information. The controller 12 may generate and output behavior proposal information that specifies the estimated time.

In other words, the controller 12 generates information that specifies a time for the user 60 to do the laundry as behavior proposal information, based on repeated behavior information that includes information related to a habit of the user 60 doing the laundry and on sunshine state information that is acquired for a predetermined spot that is a spot at which the user 60 hangs the laundry.

Specifically, the controller 12 may generate information that specifies a time for the user 60 to do the laundry so that the user 60 can hang the laundry during a time period including a time when the amount of solar radiation increases. The controller 12 may generate information that specifies a time for the user 60 to do the laundry so that the user 60 can hang the laundry during a time period when an integrated amount of solar radiation is greater than a predetermined value. The controller 12 may estimate a time for the user 60 to do the laundry based on sunshine state information indicating the sunshine state at that time, or may estimate a time for the user 60 to do the laundry based on sunshine state information indicating a tendency of changes in the amount of solar radiation.

The controller 12 may generate information that specifies a time for the user 60 to do the laundry daily as behavior proposal information. Further, the controller 12 may generate information that specifies on which day the items which are not washed daily need to be washed as behavior proposal information. The items which are not washed daily may include, for example, large laundry, such as bed covers or futon covers, curtains, or the like. For example, the controller 12 may generate information that specifies a day including a time period in which an integrated amount of solar radiation at spots included in an area required to hang large laundry is greater than a predetermined value as a suitable day for the user 60 to wash large laundry. The controller 12 may generate information that specifies not just a time to hang the laundry but a time to hang a futon or the like as behavior proposal information. The controller 12 may generate information that specifies a day including a time period with a suitable amount of solar radiation for a futon to dry as a suitable day for the user 60 to hang the futon or the like.

The controller 12 may estimate a spot at which it is likely that sunshine can be used to dry the laundry as a spot at which laundry is to be hung based on sunshine state information. The controller 12 may generate and output behavior proposal information that specifies the estimated spot. Specifically, the controller 12 may estimate a spot with the maximum amount of solar radiation as a spot at which laundry is to be hung. The controller 12 may estimate a spot at which an integrated amount of solar radiation during a time period for which the user 60 dries the laundry is greater than a predetermined value as a spot at which the laundry is to be hung. The controller 12 may estimate a spot at which laundry is to be hung based on sunshine state information indicating the sunshine state at that time, or may estimate a spot at which laundry is to be hung based on sunshine state information indicating a tendency of changes in the amount of solar radiation.

<Behavior Proposal Related to Outing>

As a repeated daily behavior, the user 60 can go outside the home. The controller 12 of the server 10 acquires repeated behavior information that includes information related to a habit of the user 60 going out. The controller 12 further acquires sunshine state information for a predetermined spot outside the home of the user 60. Based on the repeated behavior information for the user 60 and the sunshine state information for the predetermined spot, the controller 12 may estimate and output a suitable time for the user 60 to go out.

For example, the controller 12 may estimate a time when the amount of solar radiation outside the home is less than a predetermined value as a suitable time for the user 60 to go out, so that the user 60 will not be exposed to too much ultraviolet rays.

The controller 12 may estimate and propose a suitable mode for the user 60 to use when going out based on sunshine state information for a predetermined spot outside the home. For example, in a case in which the user 60 goes out at a time when the amount of solar radiation outside the home is greater than a predetermined value, the controller 12 may propose use of a mobile object 70 which is described later so that the user 60 can avoid direct sunshine. In a case in which the user 60 goes out at a time when the amount of solar radiation outside the home is greater than a predetermined value, the controller 12 may propose use of an umbrella.

The controller 12 may estimate a suitable time for the user 60 to go out further based on the season. For example, when it is a summer season, the controller 12 may estimate a time when the amount of solar radiation outside the home is less than a predetermined value as a suitable time for the user 60 to go out. For example, when it is a winter season, the controller 12 may estimate a time when the amount of solar radiation outside the home is greater than a predetermined value as a suitable time for the user 60 to go out. The controller 12 may estimate and propose a suitable mode for the user 60 to use when going out further based on the season.

The controller 12 may estimate a suitable time for the user 60 to go out based on sunshine state information for a predetermined spot in the vicinity of the home. Further, the controller 12 may estimate and propose a suitable mode for the user 60 to use when going out based on sunshine state information for a predetermined spot in the vicinity of the home. By using only sunshine state information for the vicinity of the home, the controller 12 can easily estimate a time or a mode to use.

The controller 12 may estimate a suitable time for the user 60 to go out based on sunshine state information for different spots on a route along which the user 60 goes out. Further, the controller 12 may estimate and propose a suitable mode for the user 60 to use when going out based on sunshine state information for different spots on a route along which the user 60 goes out. In this case, the controller 12 may acquire detection results from detection apparatuses 40 installed at various spots in the town.

<Summary>

As described above, the controller 12 can estimate information regarding a suitable time or the like for performing a repeated behavior of the user 60, based on sunshine state information and propose the information to the user 60. As a result, the quality of life of the user 60 can be improved.

<Example of Flowchart of Information Processing Method>

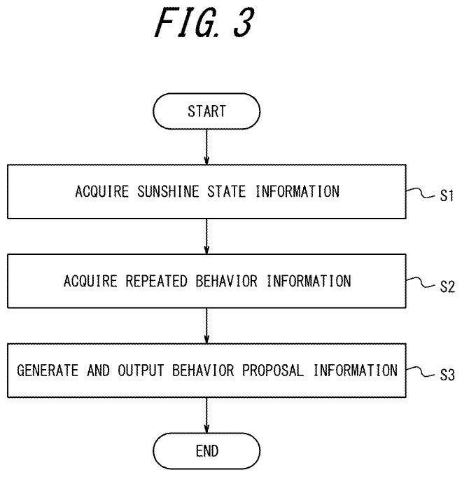

The controller 12 of the server 10 included in the information processing system 1 may execute an information processing method including the procedure of the flowchart illustrated in FIG. 3. The information processing method may be implemented as an information processing program to be executed by the processors of the controller 12 or the like. The information processing program may be stored on a non-transitory computer readable medium.

The controller 12 acquires sunshine state information (Step S1). Specifically, the controller 12 may acquire, from a detection apparatus 40, a detection result of the state of a predetermined spot or a spot in the vicinity of the predetermined spot. Based on the detection result acquired from the detection apparatus 40, the controller 12 may estimate the sunshine state of the predetermined spot and acquire it as sunshine state information for the predetermined spot. Further, the controller 12 may acquire, from a detection apparatus 40, a detection result of the amount of solar radiation itself at the predetermined spot as sunshine state information for the predetermined spot.

The controller 12 acquires repeated behavior information (Step S2). Specifically, the controller 12 may acquire, from a detection apparatus 40, a detection result of the position or a history of travel of the user 60. Based on the detection result acquired from the detection apparatus 40, the controller 12 may estimate a repeated behavior of the user 60 at a predetermined spot and acquire it as repeated behavior information of the user 60 that is associated with the predetermined spot.

The controller 12 generates and outputs behavior proposal information (Step S3). Specifically, the controller 12 generates and outputs behavior proposal information that specifies a behavior to be proposed to the user 60, based on the sunshine state information for the predetermined spot and the repeated behavior information for the user 60 that is associated with the predetermined spot. The controller 12 can propose a behavior to the user 60, for example, by causing the terminal apparatus 20 installed at the home of the user 60 to output the behavior proposal information. Further, the controller 12 can propose a behavior to the user 60 by causing the terminal apparatus 20 in the possession of the user 60 to output the behavior proposal information. After performing the procedure of Step S3, the controller 12 can end the execution of the procedure of the flowchart of FIG. 3.

As described above, according to the information processing method according to the present embodiment, information regarding a suitable time or the like for performing a repeated behavior of the user 60 can be estimated based on sunshine state information and proposed to the user 60. As a result, the quality of life of the user 60 can be improved.

### Other Embodiments

The information processing system 1 may be implemented in various other embodiments. Hereinafter, other embodiments will be described.

<Use of Mobile Object 70>

The information processing system 1 further includes, but is not required to include, a mobile object 70. A mobile object 70 may include a vehicle, such as a passenger vehicle, that the user 60 can use to go out. A mobile object 70 may be in the possession of the user 60. The number of mobile objects 70 is not limited to one and may be two or more.

The controller 12 of the server 10 may determine that the user 60 is to go out using a mobile object 70, based on repeated behavior information for the user 60. The controller 12 may propose a mobile object 70 as a mode to be used by the user 60 to go out, based on repeated behavior information for the user 60. The controller 12 may also propose a mobile object 70 as a mode to be used by the user 60 to go out, further based on sunshine state information.

In a case in which the user 60 goes out using a mobile object 70, the controller 12 may estimate a suitable time for the user 60 to go out using the mobile object 70, based on sunshine state information for a storage spot for the mobile object 70. The controller 12 may, for example, propose a time for the user 60 to go out so that the user 60 can board the mobile object 70 before the amount of solar radiation at the storage spot for the mobile object 70 exceeds a predetermined value. This prevents the user 60 from feeling hot when boarding the mobile object 70. That is, the user 60 can use the mobile object 70 comfortably. Further, when it is a summer season, the user 60 can use the mobile object 70 even more comfortably. As a result, the quality of life of the user 60 can be improved.

On the other hand, when it is a winter season, the controller 12 may propose a time for the user 60 to go out so that the user 60 can board a mobile object 70 after the amount of solar radiation at a storage spot for the mobile object 70 exceeds a predetermined value. This prevents the user 60 from feeling cold when boarding the mobile object 70. That is, the user 60 can use the mobile object 70 comfortably. As a result, the quality of life of the user 60 can be improved.

The controller 12 may output control information for controlling air conditioning equipment of a mobile object 70, to thereby cause the mobile object 70 to control the inside temperature. The controller 12 may output the control information based on repeated behavior information for the user 60 and sunshine state information for a storage spot for the mobile object 70 so that the temperature inside the mobile object 70 will be a temperature that the user 60 finds comfortable at a time when the user 60 goes out.

The controller 12 may estimate a time when the user 60 will return the home using a mobile object 70 based on repeated behavior information for the user 60. In a case in which the user 60 returns the home using the mobile object 70, the user 60 stores the mobile object 70 at a storage spot. In a case in which the user 60 is able to use more than one storage spots, the controller 12 may estimate and propose a suitable spot to store the mobile object 70. For example, the controller 12 may estimate the amount of solar radiation at each storage spot at a time when the user 60 will subsequently go out using the mobile object 70. The controller 12 may select and propose at least one spot as a storage spot for the mobile object 70 so that the user 60 can use the mobile object 70 comfortably when going out subsequently. The controller 12 may output behavior proposal information that specifies the selected storage spot to a navigational device installed in the mobile object 70. The controller 12 may output behavior proposal information to the terminal apparatus 20 in the possession of the user 60.

<Other Example Configurations of Terminal Apparatus 20>

The terminal apparatus 20 may include various configurations as well as the aforementioned configuration. Hereinafter, other example configurations will be described.

The terminal apparatus 20 may further include an input device for receiving inputs from the user 60. The input device may include, for example, a touch panel, a keyboard, or the like. The input device may include an audio input device, such as a microphone. The terminal apparatus 20 may cause the user 60 to input information related to a repeated behavior through the input device, and output the information inputted by the user 60 to the server 10. The controller 12 of the server 10 may acquire repeated behavior information for the user 60 based on the information inputted by the user 60.

The terminal apparatus 20 may include a positional information acquisition device. The terminal apparatus 20 may acquire positional information for the terminal apparatus 20 itself by the positional information acquisition device and output the positional information to the server 10. The positional information acquisition device may include a receiver compliant with a satellite positioning system. The receiver compliant with the satellite positioning system may include, for example, a Global Positioning System (GPS) receiver.

In a case in which the terminal apparatus 20 is in the possession of the user 60, positional information for the terminal apparatus 20 itself may be outputted to the server 10 as positional information for the user 60. The controller 12 of the server 10 may acquire the position or a history of travel of the user 60 based on positional information for the terminal apparatus 20.

<Example of Control in Home of User 60>

The controller 12 of the server 10 may acquire information related to the amount of solar radiation entering a room through a window in the home of the user 60 as sunshine state information. The controller 12 may estimate a suitable room for the user 60 to spend time based on the amount of solar radiation entering each room in the home of the user 60, and generate behavior proposal information so that the user 60 can spend time in that room. Further, the controller 12 may generate behavior proposal information that specifies a suitable room for performing a repeated behavior of the user 60 based on the amount of solar radiation entering each room in the home of the user 60. That is, the controller 12 may generate behavior proposal information that proposes in which room in the home the user 60 is to spend time or in which room a repeated behavior is suitable to be performed, based on the amounts of solar radiation entering the home of the user 60.

Based on the amount of solar radiation entering each room, the controller 12 can generate and output control information for controlling air conditioning equipment installed in the room. The controller 12 may generate and output control information for controlling air conditioning equipment of a room that is proposed to the user 60 for spending time.

The controller 12 may generate behavior proposal information that specifies the content to be proposed as a behavior in the home of the user 60, further based on the season. For example, when it is a summer season, the controller 12 may generate behavior proposal information so that the user 60 can spend time in a room when the amount of solar radiation entering that room through a window is less than a predetermined value. For example, when it is a winter season, the controller 12 may generate behavior proposal information so that the user 60 can spend time in a room when the amount of solar radiation entering that room through a window is greater than a predetermined value. The controller 12 may generate behavior proposal information that proposes in which room a repeated behavior is suitable to be performed, further based on the season. The controller 12 may generate control information for controlling the air conditioning equipment of each room, further based on the season.

<Other Example Behaviors Proposed to User 60>

As described above, the controller 12 can generate behavior proposal information that specifies the content to be proposed with respect to a repeated behavior in the home of the user 60 such as doing the laundry, or a repeated behavior outside the home of the user 60 such as going out. That is, the controller 12 can propose that a time or a manner of a repeated behavior of the user 60 change.

In a case in which a behavior of the user 60 that is performed at a certain time frame has become a behavior that is repeated daily, the controller 12 may generate behavior proposal information that proposes a change to a time for the behavior within the time frame. That is, the controller 12 may generate information that prompts the user 60 to perform the behavior within a predetermined time period as behavior proposal information. The controller 12 may generate behavior proposal information that proposes a change to the time frame. In other words, the controller 12 may generate information that prompts the user 60 to change the repeated behavior as behavior proposal information. The controller 12 may generate information that prompts the user 60 to change the repeated behavior and/or information that prompts the user 60 to perform the behavior within a predetermined time period, as behavior proposal information.

The embodiments according to the present disclosure have been described based on the drawings and examples. The present disclosure is not limited to the above embodiments. For example, functions or the like included in each step, or the like can be rearranged without logical inconsistency, and a plurality of steps, or the like can be combined together or divided. Other modifications can be made without departing from the spirit of the present disclosure.

1. An information processing apparatus, comprising
a controller, wherein
the controller is configured to:
acquire sunshine state information that specifies a sunshine state of at least one predetermined spot and repeated behavior information for a user that is associated with the at least one predetermined spot; and
generate behavior proposal information related to performance of a repeated behavior of the user, based on the sunshine state information and on the repeated behavior information for the user, and output the behavior proposal information.

2. The information processing apparatus according to claim 1, wherein
the controller is configured to generate the sunshine state information for the at least one predetermined spot, based on a detection result of a state of the at least one predetermined spot or a spot in the vicinity of the at least one predetermined spot.

3. The information processing apparatus according to claim 1, wherein
the controller is configured to generate the repeated behavior information for the user that is associated with the at least one predetermined spot, based on a detection result of a history of travel of the user at the at least one predetermined spot or a spot in the vicinity of the at least one predetermined spot.

4. The information processing apparatus according to claim 1, wherein
the controller is configured to acquire a history of travel of the user as the repeated behavior information for the user.

5. The information processing apparatus according to claim 1, wherein
the controller is configured to generate a time for the user to do laundry as the behavior proposal information, based on the repeated behavior information for the user that includes information related to a habit of the user doing laundry and on the sunshine state information that is acquired for the at least one predetermined spot, the at least one predetermined spot being a spot at which the user hangs laundry.

6. The information processing apparatus according to claim 1, wherein
the controller is configured to generate a time for the user to go out as the behavior proposal information, based on the repeated behavior information for the user that includes information related to a habit of the user going out and on the sunshine state information that is acquired for the at least one predetermined spot, the at least one predetermined spot being a spot outside a home of the user.

7. The information processing apparatus according to claim 6, wherein
in a case in which the user goes out using a mobile object, the controller generates a time for the user to go out using the mobile object as the behavior proposal information, further based on the sunshine state information that is acquired for the at least one predetermined spot, the at least one predetermined spot being a storage spot for the mobile object.

8. The information processing apparatus according to claim 7, wherein
the controller is configured to output, to the mobile object, information for controlling air conditioning equipment of the mobile object based on the behavior proposal information.

9. The information processing apparatus according to claim 6, wherein
in a case in which the user returns the home using the mobile object, the controller generates, as the behavior proposal information, at least one spot in a plurality of spots that can be used to store the mobile object as a storage spot for the mobile object, based on the sunshine state information that is acquired for the at least one predetermined spot, the at least one predetermined spot comprising the plurality of spots.

10. The information processing apparatus according to claim 1, wherein
the controller is configured to output information for controlling air conditioning equipment in a home of the user, based on the sunshine state information for the inside of the home of the user.

11. The information processing apparatus according to claim 1, wherein
the controller is configured to generate information that prompts the user to change the repeated behavior and/or information that prompts the user to perform the behavior within a predetermined time period, as the behavior proposal information.

12. An information processing system comprising:
the information processing apparatus according to claim 1; and
a detection apparatus configured to detect information related to the sunshine state of the at least one predetermined spot.

13. An information processing method comprising:
acquiring sunshine state information that specifies a sunshine state of at least one predetermined spot;
acquiring repeated behavior information for a user that is associated with the at least one predetermined spot; and
generating behavior proposal information related to performance of a repeated behavior of the user, based on the sunshine state information and on the repeated behavior information for the user, and outputting the behavior proposal information.

14. The information processing method according to claim 13, further comprising
generating the sunshine state information for the at least one predetermined spot, based on a detection result of a state of the at least one predetermined spot or a spot in the vicinity of the at least one predetermined spot.

15. The information processing method according to claim 13, further comprising
generating the repeated behavior information for the user that is associated with the at least one predetermined spot, based on a detection result of a history of travel of the user at the at least one predetermined spot or a spot in the vicinity of the at least one predetermined spot.

16. The information processing method according to claim 13, further comprising
acquiring a history of travel of the user as the repeated behavior information for the user.

17. The information processing method according to claim 13, further comprising
generating a time for the user to do laundry as the behavior proposal information, based on the repeated behavior information for the user that includes information related to a habit of the user doing laundry and on the sunshine state information that is acquired for the at least one predetermined spot, the at least one predetermined spot being a spot at which the user hangs laundry.

18. The information processing method according to claim 13, further comprising
generating a time for the user to go out as the behavior proposal information, based on the repeated behavior information for the user that includes information related to a habit of the user going out and on the sunshine state information that is acquired for the at least one predetermined spot, the at least one predetermined spot being a spot outside a home of the user.

19. The information processing method according to claim 18, further comprising
in a case in which the user goes out using a mobile object, generating a time for the user to go out using the mobile object as the behavior proposal information, further based on the sunshine state information that is acquired for the at least one predetermined spot, the at least one predetermined spot being a storage spot for the mobile object.

20. A terminal apparatus comprising
a terminal controller, wherein
the terminal controller is configured to:
output, to an information processing apparatus, repeated behavior information for a user that is associated with at least one predetermined spot;
acquire, from the information processing apparatus, behavior proposal information related to performance of a repeated behavior of the user, the behavior proposal information being generated based on sunshine state information for the at least one predetermined spot and on the repeated behavior information for the user; and
notify the user of the behavior proposal information.
